(19) United States
(12) Patent Application Publication
(10) Pub. No.: US 2026/0252549 A1
(43) Pub. Date: Aug. 27, 2026

(54) STRUCTURED DATA FILE UPDATE SYSTEM

(71) Applicant: BackOffice Associates, LLC d/b/a Syniti, Needham Heights, MA (US)

(72) Inventors: Cody David, Lexington, KY (US); Javeed Nizami, Needham Heights, MA (US)

(21) Appl. No.: 19/063,709

(22) Filed: Feb. 26, 2025

(51) Int. Cl. G06F 16/23

(52) U.S. Cl. CPC G06F 16/2365

(57) ABSTRACT

Methods, systems, and apparatus, including computer programs encoded on a computer storage medium, for updating a structured data file based on a request and metadata. In one aspect, a method comprises providing data representing a first structured data file to a client device for display on a user interface, wherein the first structured data file is structured according to a schema, receiving a request to modify the first structured data file from the client device, wherein the request to modify the first structured data file indicates a first revision modality, receiving metadata characterizing a context of use for the first structured data file based on the client device, generating a second structured data file by modifying the first structured data file using the first revision modality based on the request and the metadata, providing data representing the second structured data file for display on the user interface.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that can update a structured data file based on a request from a client device and metadata for the client device that characterizes the purpose of the structured data file. In particular, the system can modify the structured data file using one or more revision modalities that are compatible with the schema of the structured data file. For example, the system can receive a request from a client device that indicates a particular revision modality, e.g., a mode of editing, for the modification specified by the request and the system can revise the structured data file using the revision modality based on the request and the metadata.

In this specification, a structured data file refers to a data file that is structured according to a schema, e.g., a set organization of the data file according to predefined relationships between one or more components of the structured data file. More specifically, the system can provide a set of one or more revision modalities for revising the structured data file in accordance with maintaining the schema. As an example, the system can provide modalities corresponding with different types of inputs, e.g., a textual input, an input captured by way of an interaction with a user-interface (UI), and a code input. The system can then generate a second structured data file based on the request and the metadata by modifying the first data file using the revision modality indicated in the request. In particular, the metadata can provide context to the system to ensure that the request is valid and specifies a modification that aligns with the intended use of the structured data file.

According to a first aspect there is provided providing data representing a first structured data file to a client device for display on a user interface, wherein the first structured data file is structured according to a schema, receiving a request to modify the first structured data file from the client device, wherein the request to modify the first structured data file indicates a first revision modality for modifying the first structured data file that is selected from a set of one or more revision modalities that are compatible with the schema, receiving metadata characterizing a context of use for the first structured data file based on the client device, generating a second structured data file by modifying the first structured data file using the first revision modality based on the request and the metadata, generating a second structured data file by modifying the first structured data file in accordance with the first revision modality based on the request, and providing data representing the second structured data file to the client device for display on the user interface.

Particular embodiments of the subject matter described in this specification can be implemented so as to realize one or more of the following advantages.

The system of this specification can allow for the iterative updating of a structured data file using a set of revision modalities. In particular, the system can leverage (i) the schema of the underlying data file as a unified data model to provide a set of one or more revision modalities that can be used interchangeably to modify the underlying data file, and (ii) the metadata to ensure that the modification specified by the request serves the purpose of the structured data file.

A technical problem solved by the techniques of this specification is the siloed nature of revision systems that generally provide respective revision modalities for modifying a structured data file. By unifying the revision modalities for interchangeable use on the same structured data file, the system of this specification can reduce the computational resources needed to repeatedly access and open the structured data file using different revision systems, transfer or synchronize data between different revision systems with respect to modifications made to the same structured data file, and even render the structured data file, e.g., which can require a specific rendering engine for each revision system. Furthermore, the system of this specification can reduce the computational resources needed to store different copies of the same structured data file across different revision systems.

Additionally, the unification of the revision modalities can support the online improvement of the system to generate more relevant suggestions of predicted revisions. In particular, the system can provide for the seamless switching between revision modalities without losing context or progress, representing a significant improvement in the capture of revision data with respect to systems that silo these functionalities. More specifically, the unification of the revision modalities can support the logging of sequential revision data with respect to a particular structured data file, which can provide more useful information to the system with respect to the editing process than data that is segmented by revision modality.

Furthermore, the system enables flexibility by allowing for the modification of the structured data file using any of the set of revision modalities that correspond with the underlying schema of the structured data file. More specifically, the system provides for the seamless switching between revision modalities while revising a structured data file since all revision modalities adhere to the unified data model for the structured data file that is provided by the schema. By allowing users to select the most convenient method for their needs when modifying a structured data file, the system can enhance productivity, since some revisions can be more efficiently carried out using a particular revision modality than others.

Moreover, some revision modalities are not as precise as others, and different revision modalities can be used consecutively to achieve more robust modifications to the structured data file. In an example described in this specification, the system can process a textual input using a language processing neural network to generate an updated structured data file. Generally, content generated by language processing neural networks is not considered to be a final work product without further revision and refinement. In another example described in this specification, the system can provide the updated structured data file that was generated using the language processing neural network to a client device using a “what you see is what you get” (WYSIWYG) user interface, thereby allowing a user to interact directly with a display of the updated structured data file to enter a UI input specifying a further modification. Thus, the system can promote robust modification of a structured data file using multiple revision modalities.

Another technical problem solved by the techniques of this specification is the incorporation of metadata as context in order to tailor requested revisions to a structured data file to their purpose or use case. In some cases, the system can validate the request using the metadata, e.g., to ensure that the modification specified by the request to the structured data file is in accordance with the schema of a database maintained by the client device as well as related validations, constraints, and check conditions. More specifically, the system can process metadata that includes data from a client device and domain knowledge, e.g., specialized knowledge for a particular application, as context for the intended use of the structured data file when generating the updated structured data file. By ensuring that the system modifies the structured data file in a manner informed by the context, the system can provide more targeted modifications that align with the purpose of the structured data file, e.g., relative to a system that ignores the context of the structured data file when updating the structured data file based on user requests.

Furthermore, by including domain knowledge in the metadata, the system can more efficiently generate modification suggestions for multiple client devices that share a common use case. In some cases, different client devices can aim to generate a structured data file for a similar use case, e.g., for contact information data entry. In this case, the system can bypass the need to fully reprocess the metadata and the updated structured data file to generate suggestions by using the common domain knowledge of data that defines a contact to inform potential modifications, e.g., by identifying similarities from previously generated structured data files that were adapted for the similar use case. Thus, the system can reduce the use of computational resources required to generate suggestions by leveraging shared domain knowledge in the modification of similar structured data files.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a system diagram of an example structured data file update system that includes a modification execution subsystem that can modify a structured data file based on a request and received metadata.

FIG. 2 demonstrates how an example modification subsystem can receive and process metadata for different client devices.

FIG. 3 is a block diagram that illustrates how a structured data file update system can update a structured data file based on a textual input.

FIG. 4 depicts an example user interface (UI) that a structured data file update system can provide to a client device to receive a UI input as the request.

FIG. 5 is a system diagram of an example modification execution subsystem.

FIG. 6 is a flow diagram of an example process for updating a structured data file using a specific revision modality.

FIG. 7 illustrates an example of a computing device and a mobile computing device that can be used to implement the techniques described here.

Like reference numbers and designations in the various drawings indicate like elements.

### DETAILED DESCRIPTION

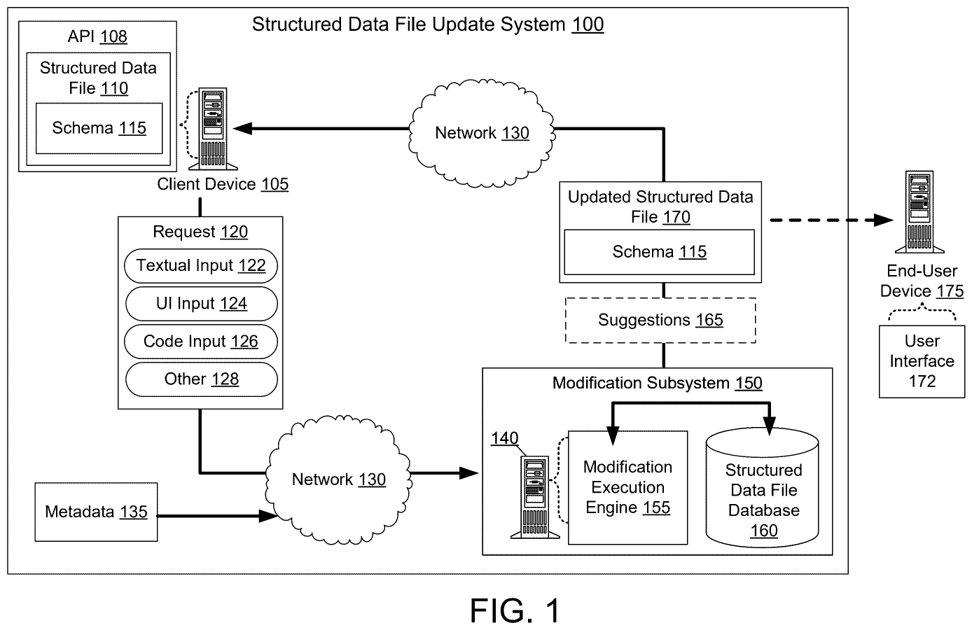

FIG. 1 shows an example structured data file update system 100. The data file update system 100 is an example of a system implemented as computer programs on one or more computers in one or more locations in which the systems, components, and techniques described below are implemented.

In this example, the structured data file update system 100 can allow a client device 105 to modify a structured data file through a set of provided revision modalities that are each compatible with a structured data file 110. In this specification, a structured data file is a data file that is structured according to a schema. In this case, the structured data file 110 is structured according to the schema 115 which defines the relationships between one or more components and any sub-components of the structured data file 110.

In particular, the structured data file update system 100 can include a modification subsystem 150 that can update a structured data file 170 using a particular revision modality that is specified by a request 120. More specifically, the structured data file update system 100 can employed by a number of client devices, e.g., the client device 105, to generate an updated structured data file 170.

The system 100 can provide an applied programming interface (API) 108 over a network 130 that enables the client device 105 to render and display a structured data file 110. As an example, the API 130 can be provided over the same network 130 as the user uses to receive and render data. For example, the network 130 can be the Internet or an internally provided network, e.g., an intranet.

For example, the structured data file 110 can be a hierarchical data file, e.g., an HTML (Hypertext Markup Language), XML (Extensible Markup Language), or JSON (JavaScript Object Notation) file, that specifies the relationships between the different components of the schema 115 using a nested dictionary structure. As another example, the structured data file 110 can be a tabular data file, e.g., a comma-separated value (csv), tab-separated value file, or a custom-delimiter file. As yet another example, the structured data file 110 can be a log file or a configuration data file. As a further example, the structured data file 110 can be a database file, e.g., a SQL, NoSQL file, parquet file, avro file, etc.

For example, the system 100 can obtain the structured data file 110 from a structured data file database 160. As another example, the system 100 can generate the structured data file 110, e.g., in response to a user request to generate a structured data file. In particular, the system 100 can generate the structured data file 110 by processing the user request to generate a structured data file using a model that is configured to generate a structured data file 110 with the schema 115, as is described in more detail below. In other cases, the system 100 can receive the structured data file from the client device 105 or another system, e.g., by accessing the structured data file from a data repository of the client device 105 or the other system, respectively.

In particular, the system 100 can provide data to the client device 105 that, when executed by a rendering engine of the client device 105, renders the API 108 and the structured data file 110 on a display of the client device 105. The API 108 can also enable the client device 105, e.g., the user of client device 105, to input a request 120 to the modification subsystem 150 using the same network 130. More specifically, the structured data file update system 100 can provide the API 108 as an interface for the user to view the structured data file 110 and input a request 120 to modify the structured data file 110, e.g., based on a desired modification to the displayed structured data file 110.

For example, the system 100 can provide a set of revision modalities that are compatible with the schema 115 of the structured data file 110. In particular, the system 100 can provide a set of revision modalities that correspond with different modes of editing the structured data file 110 without updating the schema 115, e.g., each revision modality can modify an aspect of the structured data file 110 while respecting the underlying schema 115 inherent to the structured data file 110. As an example, in the case that the structured data file 110 is an HTML, XML, or JSON file, the system 100 can provide a set of revision modalities to update pages, panels, columns, or themes of the structured data file 110 while not changing the underlying nested dictionary structure. As another example, in the case of a csv or tsv, the system 100 can provide a set of revision modalities to update the content of the structured data file 110 while not changing the underlying comma or tab separation structure of the file.

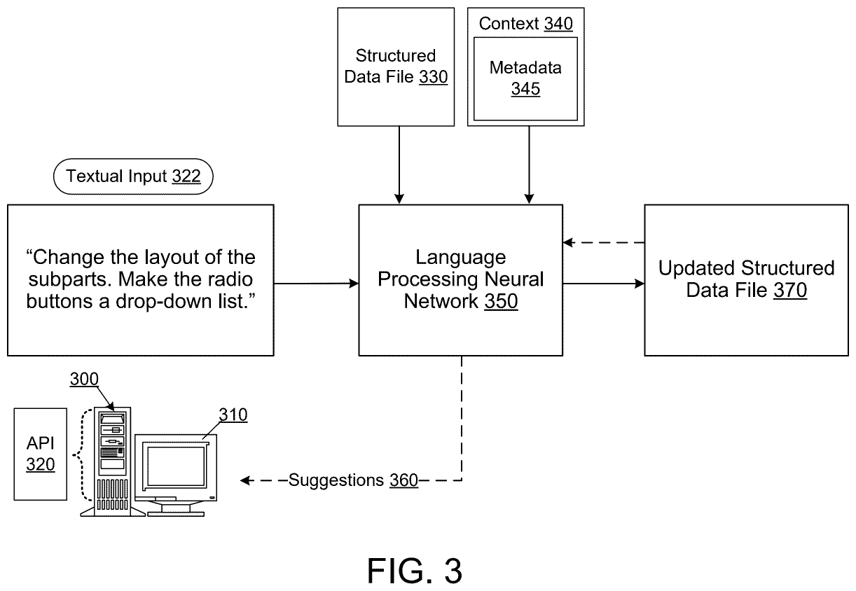

In the particular example depicted, the system 100 provides a set of revision modalities that correspond with each of a textual input 122, a UI input 124, and a code input 126. As an example, the textual input 122 refers to a textual instruction specifying one or more modifications to the structured data file 110. For example, the textual input 122 can include a direction to “Change the color of the panel on the left” or “Modify the radio buttons with text underneath to selectable icons” as the request 120. In particular, the textual input 122 can be a prompt that contains a directive instruction to modify the structured data file 110, e.g., for a language processing neural network. An example for processing a textual input using a language processing neural network will be described in more detail with respect to FIG. 3.

As another example, the UI input 124 can be specified by way of an interaction with the structured data file 110 on the API 108. In particular, the system 100 can provide an interactive, e.g., drag-and-drop interface, for rearranging the components of and updating the content included in the structured data file 110. For example, in response to a selection of a component, the system 100 can provide a number of update options to the client device for the component, e.g., a color change, a layout change, an option to move the component elsewhere on the API 108, etc. In this case, the system 100 can receive a selection of an option specifying the desired modification to the component as the request 120. An example for processing a UI input 124 from a “what you see is what you get interface” (WYSIWYG) will be described in more detail with respect to FIG. 3.

As yet another example, the code input 126 can include a direct modification to the structured data file 110. In particular, in the case that the structured data file 110 is a hierarchical data file, the code input 126 can directly modify the content of the HTML, XML, or JSON file. In this case, the system 100 can provide an integrated development environment or another form of code editor to the client device 105, e.g., by way of the API 108. As an example, the system 100 can be configured to provide the code editor to the client device 105 upon receiving a request to modify the structured data file 110 directly, e.g., from a user of the client device 105 that understands HTML, XML, or JSON code.

In some cases, the system 100 can generate the code input 126, e.g., in response to a request from the client device 105, e.g., a user of the client device, to generate a code input 126. For example, the system 100 can generate the code input 126 using a generative machine learning model that is configured to generate a structured data file 110 with the schema 115, e.g., a language processing neural network that is instructed to generate structured data files with the schema 115. In this case, the system 100 can generate the code input 126 and provide the code input 126 to the modification subsystem 400. As an example, the system 100 can generate the code input 126 as a response to a request to generate a first version of a structured data file. In this case, the code input 126 includes the instructions for the first version of the structured data file.

In particular, the system 100 can provide a textual input revision modality, a UI input revision modality, and a code input modality corresponding with each of the inputs 122, 124, and 126. By providing multiple revision modalities, e.g., as opposed to a single modality for direct modification using code, the system 100 can broaden its potential user base to include users that do not know how to code. While described here with respect to the textual input 122, the UI input 124, and the code input 126, the system 100 can provide any appropriate revision modality for the schema 115 of the structured data file 110 for the schema 115 of the structured data file 110. For example, the other input 128 can be an audio input specifying a modification to the structured data file 110 through a recorded audio clip.

The system 100 can receive the request 120 from the client device 105, e.g., using the network 130, and can also receive metadata 135 that characterizes the use of the structured data file. In particular, the metadata 135 can include data from the client device 105 and domain knowledge related to the purpose of the structured data file 110. For example, the data from the client device 105 can include metadata derived from the schema of a database maintained by the client device 105 as well as procedural data relating to different processes that can be performed using data stored in the database, e.g., the relationships between tables with respect to a particular process. As another example, the metadata 135 can include different rules, constraints, and check conditions that are used to validate the configuration of the structured data file, e.g., the intended business process(es) intended for the structured data file, as will be described in more detail below.

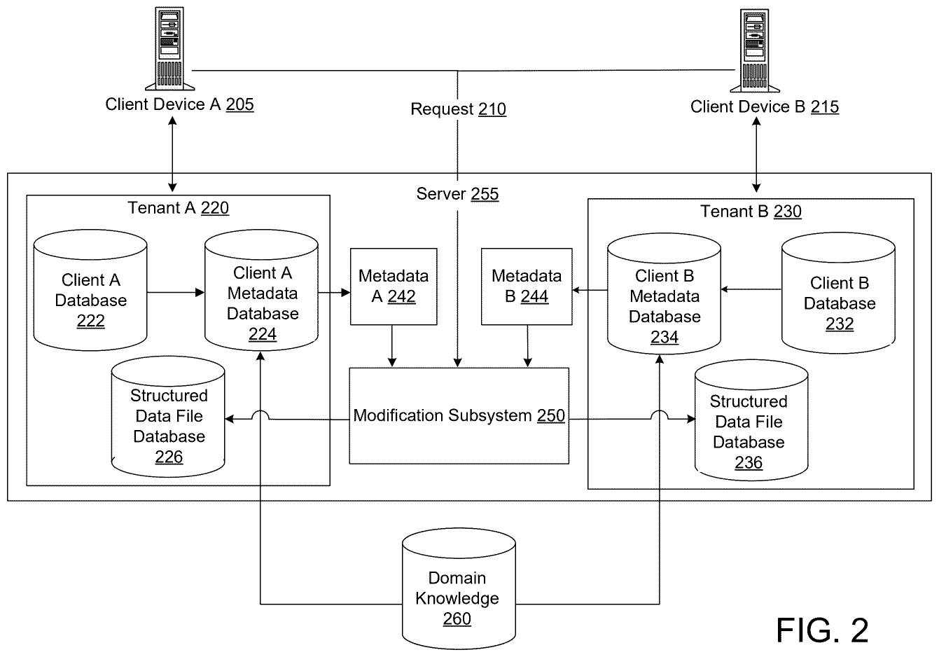

In some cases, the metadata 135 can be received from another system that maintains data from the client device 105 as well as domain knowledge related to the purpose of the structured data file, e.g., specialized knowledge for the particular application of the structured data file. An example of a server that hosts metadata for two different clients in separate tenants will be described in more detail with respect to FIG. 2. As an example, the metadata 135 can include the underlying data schema that will be rendered or processed using the structured data file 110. In some cases, the metadata 135 is generated using data refinement, analytics, or both.

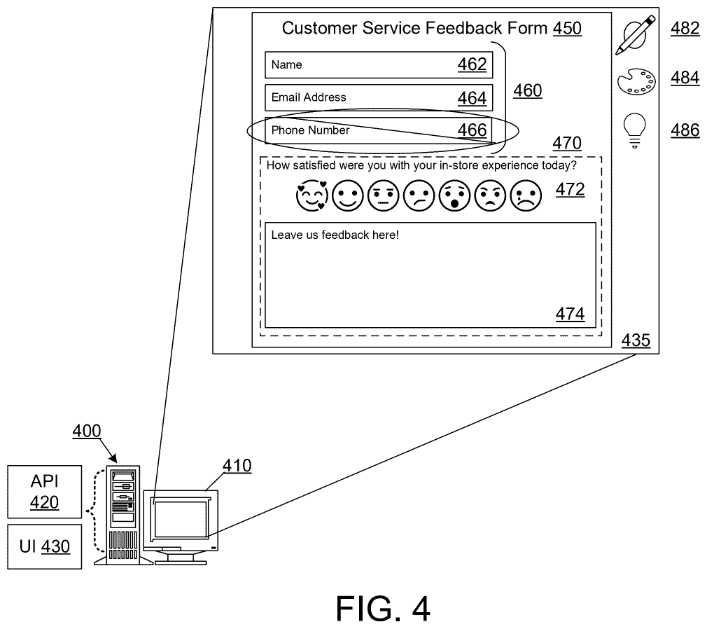

The system can process the request 120, including the indicated revision modality based on the type of request 120 received, and the metadata 135 using a modification subsystem 150, e.g., on computing device 140. In particular, the system 100 can process the request 120 and the structured data file 115 using a modification execution engine 155 to generate an updated structured data file 170 with the same schema 115 as the previous version of the structured data file. More specifically, the system 100 can generate the updated structured data file 170 based on the one or more modifications specified by the request 120 and in accordance with the context for use provided by the metadata 135. An example modification execution engine 155 will be described in more detail with respect to FIG. 4.

The modification subsystem 150 can maintain the generated updated structured data file 170 in a structured data file database 160. For example, the database 160 can include data structures for each structured data file that are populated with different versions of generated structured data files 170. In the particular example depicted, the structured data file database 160 can include a table that includes different version of the structured data file 110, e.g., the structured data file 110, the updated structured data file 170, and any previous versions of the structured data file 110. As an example, each row in the data table can correspond with a particular version of the structured data file and can include a unique version identifier, a timestamp documenting the time of generation of the particular version, and additional metadata related to the particular version.

In particular, the subsystem 150 can use the unique version identifier for version control, e.g., in the case of an inputted revision error or a desire to revisit a prior version for modification. For example, the subsystem 150 can use the unique version identifier to identify a previous version of a particular structured data file 110, e.g., in response to a request from the client device 105 to view or modify a previous version of a structured data file. In this case, the subsystem 150 can access the structured data file database 160, identify the requested structured data file, and provide the identified structured data file to the client device 105.

The subsystem 150 can also use the unique version identifier to promote quality assurance in production systems. For example, in the case that the structured data file has been deployed in a production system, the subsystem 150 can freeze the structured data file that is deployed in the production system to prevent any further editing, while allowing for continued revisions to a development structured data file that is generated from the deployed structured data file. Thus, the system can promote quality assurance and support the continuous modification of a structured data file that can be deployed as a next production structured data file.

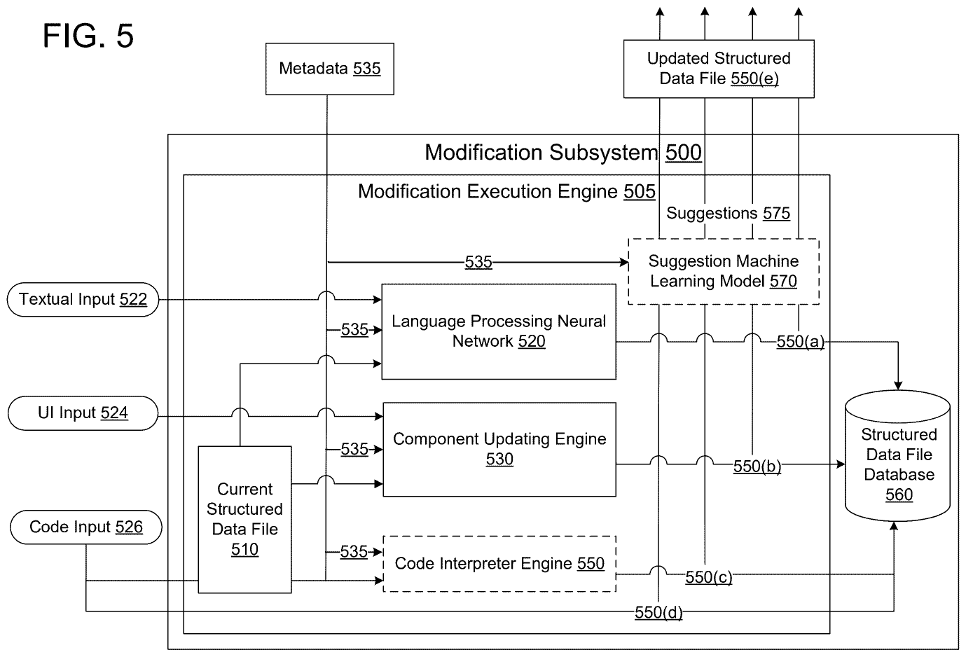

In some cases, the modification execution engine 155 can additionally generate suggestions 165, e.g., outputs that characterize a potential further modification to the updated structured data file 170. For example, the modification subsystem 150 can include a suggestion machine learning model that has been configured to process the updated structured data file 170 to generate suggestions 165 based on previously received requests. In some cases, the suggestion machine learning model can be conditioned using the metadata 135, e.g., the suggestions 165 generated can be informed by the context provided by the metadata 135. Examples for generating suggestions will be described in more detail with respect to FIGS. 3 and 5.

The system 100 can transmit the updated structured data file 170, e.g., using the network 130 to the client device 105, e.g., to update the display of the structured data file 110 to the updated structured data file 170 using the API 108. In some cases, the system 100 can receive an additional request for further updating of the updated structured data file 170. In this case, the additional request can be the same revision modality as the first request, e.g., the request 120, or a different revision modality. The system 100 can then generate another updated structured data file (not pictured) by modifying the updated structured data file 170 in accordance with the revision modality based on the additional request and the metadata 135. Generally, the metadata 135 the system processes to update the updated structured data file 170 is the same as the metadata 135 the system processed to update the structured data file 110, e.g., in the case that the use case of the structured data file remains the same or similar. In the case that the purpose of the structured data file changes, the system 100 can receive different metadata that characterizes the modified context of use for the structured data file.

Thus, the structured data file update system 100 allows a client device 105 to iteratively modify a structured data file 110 using a unified set of revision modalities. In particular, the system 100 can provide maximal flexibility in revision by allowing users to switch seamlessly between different revision modalities when generating multiple versions of a structured data file 110. Furthermore, the system 100 can encourage users to explore and become familiar with different revision modalities than a user might have favored when first using the system 100 to modify a structured data file 110.

In some cases, e.g., after a final modification is made, the updated structured data file 170 can be provided to an end-user device 175. For example, the end-user device can be operated by a different entity than the client device 105. In this case, the end-user device 175 can display the structured data file 170 by way of a user interface 172, e.g., for interaction with the structured data file 170 without further modification.

For example, the system 100 can be used to generate mini-applications, e.g., small (in computational memory) software applications that are configured to provide a particular functionality and can be integrated into a different system, e.g., a software platform, without further installation. For example, the system 100 can be used to generate a data management mini-application that is at least partially encoded in a JSON file as the structured data file 110.

As an example, the data management mini-application can be used to identify and correct errors in data entry, e.g., data that does not match the expected schema or fails at least one of the validations, constraints, and check conditions as indicated by the metadata 135. In particular, a user of the end-user device 175 can use the structured data file for the mini-application to evaluate a particular data field, e.g., the name or address, of data that was previously entered using the data management application. In this case, a user of the client device 105 can generate the updated structured data file 170 for a data entry application that the user of end-user device 175 can use to correct errors in the address, e.g., missing zip codes in a collected dataset.

For example, in the previous structured data file, the address input field can have been a short-input entry. In this case, the metadata 135 can indicate that the short-input entry led to errors in data collection, e.g., since the missing zip codes were not entered because there was no dedicated zip code input portion. As an example, the user of client device 105 can update the previous structured data file to ensure that the address is submitted in various short-input entry fields that each correspond with a street address field, city field, state field, and zip code field.

In this case, the metadata 135 can include both the expected schema and the validations, constraints, and check conditions of the underlying data for collection, and the system 100 can validate the submitted requests using the metadata 135 to ensure that each request aligned with the use case of correcting data through the mini-application. That is, the system can use the obtained metadata to ensure that the modification to the structured data file 110 specified by a request is in accordance with the schema of a database maintained by the client device as well as related validations, constraints, and check conditions.

More specifically, the system 100 can use the metadata 135 to inform the configuration of the structured data file 110 to ensure that inconsistent data is not entered as a result of the configuration of the structured data file 110. As an example, the metadata 135 can include a constraint to ensure that prospective dates entered into the mini-application are defined in the future. As another example, the metadata 135 can include a constraint to ensure that a discount entered into the mini-application is not greater than a threshold percentage. In both cases, the system 100 can validate that incoming requests do not violate these constraints.

For example, the user of client device 105 can have specified the change to the previous structured data file using a UI input 124 as the request 120. In this case, the set of options that the system provided for selection through the UI input 124 can have been informed by the metadata 135 for the use case of data entry, e.g., based on comparing the components of the structured data file with the expected schema of the missing data to be entered.

As another example, the user of client device 105 can have specified the change to the previous structured data file using a textual input 122 as the request 120. In this case, the system can process the textual input 122 and the metadata 135 using a language processing neural network with an instruction to evaluate whether the request 120 specified by the textual input 122 is executable, relevant, or both with respect to the metadata 135. In response to validating the request 120, the system can then update the previous structured data file based on the request 120 and the metadata 135.

For example, the system 100 can generate and provide the updated structured data file for use as a mini-application for data correction, e.g., on end-user device 175. In particular the mini-application can be configured to read data from a data storage location, e.g., a database accessible to the client device 175, render the data using the updated structured data file for correcting, receive the data corrections, and transmit the updated data back to the data storage location. Likewise, the system 100 can be provide for the generation of any other type of other custom mini-application for various uses, e.g., a payment application, a production order application, an entertainment application, a service booking application, an inventory forecasting application, etc.

FIG. 2 demonstrates how an example modification subsystem can receive and process metadata for different client devices.

In particular, FIG. 2 illustrates two client devices: client device A 205 and client device B 215. In this case, each client device is associated with a respective tenant on a server 255. For example, the client devices 205 and 215 can access their respective tenants 220 and 230 on the server 255 through a network connection, e.g., an intranet or cloud-based connection. In another example, the tenants 220 and 230 can be located on different servers and the modification subsystem 250 can be located on a separate processing server.

In the particular example depicted, the tenants A 220 and B 230 are siloed but maintained by the same server 255, e.g., tenant A 220 is associated with client device A 205 and tenant B 230 is associated with client device B, and neither client device A 205 nor client device B 230 can access any additional tenants. The tenants 220 and 230 are siloed to maintain the privacy/security of the data maintained within the respective tenants. More specifically, tenant A 220 can host the client A database 222, the structured data file database 226, and the client A metadata database 224; and tenant B 230 can host the client B database 232, the client B metadata 234, and the structured data file database 236. By siloing client A's data and client B's data, the system can maintain the integrity of the data and prevent security breaches, e.g., in some cases, the client database 232 and 234 can include personal identifying information of third-parties that should not be shared with client devices other than client device A 205 and client device B 215, respectively.

In particular, the client metadata databases 224 and 234 include data from the respective client databases 222 and 232, respectively, as well as shared domain-knowledge 260. For example, the data from the client databases 222 and 232 can include metadata derived from the schema of the databases 222 and 232 as well as procedural data relating to different processes that can be performed using data stored in the database, e.g., the relationships between tables with respect to a particular process. Additionally, or alternatively, the metadata 224 and 234 can include different rules, constraints, and check conditions that are used to validate the sensibleness of the configuration of the structured data file, e.g., logical rules that provide a quality check on expected inputs to a finalized structured data file 110.

In this case, users of client device A 205 and client device B 215 overlap in at least a portion of the use cases of the structured data files they generate using the system. For example, both can submit a similar request 210 to modify a structured data file for use in data entry of contact information for a service provider, e.g., the user of client device A 205 can aim to generate a mini-application for use in entering contact information for a home task service provider and the user of client device B 215 can aim to generate a mini-application for use in entering contact information for a tourism agency.

While the use case of the mini-applications is different, the mini applications both serve the similar purpose of facilitating the collection of contact information. In this case, the domain knowledge provided for inclusion in the client A metadata database 224 and the client B metadata database 234 can be similar, e.g., domain knowledge regarding customer contact information. However, while the domain knowledge 260 can be shared for the use case of the structured data files, the data included in the client A metadata database 224 will relate to the home task service provider data that is maintained in client A database 222, and the data included in the client B metadata database 234 will relate to the tourism agency data that is maintained in client B database 232. Therefore, the metadata A 242 and the metadata B 244 will differ.

Thus, the system can process the request 210 and the metadata 242 using the modification subsystem 250 to generate an updated structured data file for client device A 205 that is different than the updated structured data file generated by processing the request 210 and the metadata 244 for client device B 215. More specifically, the modification subsystem 250 can generate a tailored modification to the structured data file for the use case specified by the metadata 242, e.g., for the home task service provider customer contact entry form, and the metadata 244, e.g., for the tourism agency customer contact entry form. As an example, the tourism agency customer contact entry form can include additional input portions relating to the citizenship of the customer and how long they are staying in the area of the tourism agency, which would be unnecessary inputs for the home task service provider to collect using the home task service provider customer contact entry form.

FIG. 3 is a block diagram that illustrates how a structured data file update system can update a structured data file by processing a textual input as a request and metadata using a language processing neural network 350. For example, the structured data file update system 100 of FIG. 1 can update a structured data file using a language processing neural network 350. In some cases, the language processing neural network 350 is included in the modification execution engine 155 of FIG. 1, as will be described in more detail with respect to FIG. 4.

In the particular example depicted, a client device (e.g., computer system 300) presents on a display 310 an API 320 that allows a user of the client device 300 to interact with a structured data file. In this case, the user has input a textual input 322 to the system by way of the API 320 specifying a directive instruction to “change the layout of the subparts” and “make the radio buttons a drop-down list”. The system can process the current structured data file 330 using the language processing neural network 350 and the metadata 345 for the textual input with the instructions in the textual input 322 to generate the updated structured data file 370. In this case, the metadata is considered context 340 for the language processing neural network 350, e.g., the language processing neural network can condition the generation of the updated structured data file 370 based on the metadata 345.

The language processing neural network 350 can have a recurrent neural network architecture that is configured to sequentially process the contents of the structured data file 330 and trained to perform next element prediction, e.g., to define a likelihood score distribution over a set of next elements. More specifically, the language processing neural network 350 can be a recurrent neural network (RNN), long short-term memory (LSTM), or gated-recurrent unit (GRU). As another example, the language processing neural network 350 can be transformer-based, e.g., an encoder-decoder transformer, an encoder-only transformer, or a decoder-only transformer, configured to perform parallel processing of the contents of the multimodal input using a multi-headed attention mechanism.

As a particular example, the language processing neural network 350 can be a foundation model such as a large language model (LLM). Large language models have been demonstrated to achieve state of the art performance in semantic understanding, e.g., their ability to effectively capture semantic information from inputs. In this case, the textual input 322 can be considered as a prompt that includes two instructions which can be processed by a language processing neural network 350 to affect the modifications specified by the prompt to the structured data file 320.

In some cases, the system can additionally generate one or more suggestions 360 for further editing the updated structured data file 370. In the particular example depicted, the system can use the language processing neural network 350 as the suggestion machine learning model described in FIG. 1. More specifically, the system can process the updated structured data file 370 using the language processing neural network 350 with an instruction to generate one or more suggested revisions for the updated structured data file 370 to generate the suggestions 360. Additionally, the system can process the metadata 345 with the updated structured data file 370 using the language processing neural network to condition the generation of the suggestions 360 based on the metadata 345. In particular, the context 340 provided by the metadata 345 can allow for the generation of more targeted suggestions 360 for the use case of the structured data file.

As discussed with respect to FIG. 1, the system can then provide the suggestions 360 for further editing back to the client device 300, e.g., for display on the API 320. In some cases, the system can receive an additional request that includes one or more of the suggestions 360. In this case, the system can process the additional request, the updated structured data file 370, and the metadata 345 using the language processing neural network 350 to generate an additional updated structured data file 370 that has been modified according to the one or more suggestions 360 specified by the additional request.

FIG. 4 depicts an example user interface (UI) that a structured data file update system can provide to a client device for displaying a data source and inputting a UI input by way of the API affiliated with the UI. For example, the structured data file update system 100 of FIG. 1 can provide the UI and the API affiliated with the UI to a client device.

In the particular example depicted, a client device 400 presents on a display 410 a user interface 435 that allows a user to interact with a provided data source by way of an affiliated API 430. For example, the data source can be provided over a network, such as the internet or an internally available network. In the illustrated example, the provided data source is the structured data file for a customer service feedback form 450, which has been received and rendered by the computer system 100 and is presented on the display 410.

As an example, the structured data file can be a JSON file that includes data specifying each of the components of the customer service feedback form 450. In this case, the customer service feedback form 450 includes two separate components: a contact information component 460, e.g., which includes the short-text input portion sub-components for the name 462, email address 464, and phone number 466, a feedback component 470, e.g., a radio button sub-component 472 and a long-form input portion sub-component 474.

In particular, the UI 430 affiliated with the API 420 can be a “what you see is what you get” (WYSIWYG) interface. In this context, a WYSIWYG interface is a UI that enables a client device 400, e.g., the user of client device 400, to edit and modify the content and layout of the provided data source, e.g., the customer service feedback form 450, by directly interacting with the content and layout presented on the display 410. More specifically, the structured data file update system can provide the UI 225 and affiliated API 420 as an interface for the client device 400, e.g., a user of the client device, to input a UI input as a request to modify the structured data file of the system.

In particular, the API 420 can enable a user, e.g., the user of computer device 400, to select and modify different components of the customer service feedback form 450 by editing and modifying the content and layout of the form 450. For an example, the UI 435 can include different buttons that each correspond with an interaction tool, e.g., a content editing tool button 482, a format editing tool button 484, and a suggestion button 486.

For example, the user of client device 400 can click and edit different components of the customer service feedback form 450. As an example, the user of client device 400 can select the content editing tool button 482 and then select the phone number short-input text portion 466 to indicate a desire to modify the short-input text portion 466. As an example, in response, the system can provide a dropdown menu that includes a set of options for modifying the short-input text portion 466, e.g., an option to remove the phone number short-input text portion 466 from the customer service feedback form 450, an option to break up the phone number short-input text portion 466 into separate area code, exchange code, and line number sub-portions, or an option to make the phone number short-input text portion 466 an optional input for an end-user of the customer service form 450.

In particular, the set of options provided for modifying the different components of the customer service feedback form 450 can be determined using the metadata for the computing device 400. For example, in this case, the metadata can indicate that a typical customer profile includes a separate area code field, e.g., in a table of the corresponding metadata database maintained for the computing device 400, and the system can present the option to break up the phone number short-input text portion 466 into separate area code, exchange code, and line number sub-portions in accordance with the metadata.

The system can receive a selection of an option as a UI input. In particular, in response to the selection of an option, e.g., the option to remove the phone number short-input text portion 466 from the form 450, the system can process the UI input, the currently displayed structured data file for the customer service feedback form 450, and the corresponding metadata for the computing device 400 to generate an updated structured data file for a new version of the customer service feedback form 450, e.g., without the phone number short-input text portion 466.

As another example, the user of client device 400 can select the format editing tool button 484. For example, the user can then drag-and-drop any of the components or the sub-components of the customer service feedback form 450, e.g., the components 460 and 470, or the sub-components 462, 464, 466, or the sub-components 472 and 474, to rearrange the format of the customer service feedback form 450. In this case, the system can receive the rearranged components or sub-components as a UI input, e.g., by way of event listeners. The system can then process the UI input, the currently displayed structured data file for the customer service feedback form 450, and the metadata to generate an updated structured data file for a new version of the customer service feedback form 450, e.g., with the components rearranged as specified by the UI input.

As yet another example, the user of client device 400 can select the suggestion tool button 486. In this case, the system can provide one or more suggestions to the client device 400 by way of the UI 435, e.g., by generating the suggestions as is discussed in more detail with respect to FIG. 4. In particular, the UI can present a pop-up window (not depicted) that includes the one or more suggestions. For example, the pop-up window can include a suggestion to update the radio button icons to a slider with displayed numbers on a scale of 1-10. In the case that the user selects one of the suggestions, the system can receive the suggestion as a UI input. Likewise, the system can then process the UI input, the currently displayed structured data file, and the metadata for the customer service feedback form 450 to generate an updated structured data file for a new version of the customer service feedback form 450, e.g., with the slider.

In all cases, the system can then provide the updated structured data file to the client device 400 as a new data source, and the client device 400 can receive, render, and present the updated customer service feedback form on the display 410, e.g., with minimal lag. More specifically, since the UI 435 is a WYSIWYG UI, the system can receive the UI input, generate the updated structured data file based on the UI input and the metadata, and transmit the updated structured data file to the client device 400 in accordance with real-time or near real-time computing constraints. In particular, the system can ensure that there is minimal latency between receiving the UI input through the user's interaction with the structured data file by way of the UI 435 and the display of the updated structured data file, e.g., by efficiently processing the UI input and the structured data file to generate the updated structured data file and leveraging adaptive rendering techniques.

FIG. 5 is a system diagram of an example modification subsystem. For example, the modification subsystem 150 of FIG. 1 can be implemented as the modification subsystem 500.

As described with respect to FIG. 1, the modification subsystem 500 can receive a textual input 522, a UI input 524, or a code input 526 as a request and can process the request, the current structured data file 510, and the metadata 535 using a modification execution engine 505 to generate an updated structured data file 550(a). As an example, in the case that the client device is submitting consecutive requests with respect to multiple versions of the current structured data file 510 to the system, the subsystem 500 can cache the current structured data file 510 in a quick-retrieval memory, e.g., random access memory. As another example, in the case that the client device receives a request with respect to a different structured data file than the current structured data file that is currently being rendered by the client device, the subsystem 500 can obtain the current structured data file 510, e.g., from the structured data file database 560, through a user upload of the structured data file corresponding with the request, from another system, etc.

For example, in the case that the subsystem 500 receives a textual input 522, the modification execution engine 505 can process the textual input 522, the current structured data file 510, and the metadata 535 using a language processing neural network 520. In particular, the engine 505 can process the current structured data file 510 and the metadata 535 using the language processing neural network 520 with instructions in the textual input 522 to generate the updated structured data file 550(a). For example, in the case that the language processing neural network 520 is a large language model, the instructions in the textual input 522 can be a prompt for the LLM and the metadata 535 can be considered as context.

As another example, in the case that the subsystem 500 receives a UI input 524, the subsystem 500 can process the UI input 524, the current structured data file 510, and the metadata 535 using a component updating engine 530. In particular, the component updating engine 530 can generate the updated structured data file 510 to support the update of a WYSIWYG UI, e.g., the UI 330 of FIG. 3, with minimal lag on the display of the client device. More specifically, the subsystem 500 can generate the updated structured data file 550(b) using the component updating engine 530 and transmit the updated structured data file 550(b) to the client device in accordance with real-time or near real-time computing constraints. For example, the component updating engine 530 can be implemented using a high-performance central processing unit (CPU) or a graphics-processing unit (GPU).

As yet another example, in the case that the subsystem 500 receives a code input 526, the subsystem 500 can process the code input 526, the current structured data file 510, and the metadata 535 using a code interpreter engine 540. In this case, the subsystem 500 can parse the modifications using the code interpreter engine 540 to generate the updated structured data file 550(c) and the updated structured data file 550(c) can be interpreted from the format used in the current structured data file 510 into a coding language, e.g., that can be executed to render the updated structured data file 510 on the API.

As a further example, in the case that the code input 526 includes a direct modification to the structured data file 510, the subsystem 400 can bypass the need to process the code input 526, the current structured data file 510, and the metadata 535 using the code interpreter engine 550 and directly provide the updated structured data file 550(d).

After the updated structured data file 550(e), e.g., the updated structured data file 550(a), 550(b), 550(c), 550(d), etc., is generated, the subsystem 500 can maintain the updated structured data file 550(e) in a structured data file database 560, e.g., with previously generated structured data files or structured data files that have been received from a client device or a different system. As an example, the subsystem 500 can access and identify different versions of the updated structured data file 550(e) from the database 560, e.g., in response to a user request.

In some cases, the modification subsystem 500 can be configured to generate suggestions 575 with respect to the generated updated structured data file 550(e). In the particular example depicted, the execution engine 505 can generate the suggestions 575 using a suggestion machine learning model 570. In this case, the suggestion machine learning model 570 can be configured to process the updated structured data file 550(e) and the metadata 535 to generate one or more suggestions 575 for further editing.

The suggestion machine learning model 570 can have any appropriate machine learning architecture, e.g., a random forest, a support vector machine, a decision tree, linear regression model, or a neural network, that can be configured to process the updated structured data file 550€ and the metadata 535 to generate suggestions 575. In the case that the suggestion machine learning model 570 is a neural network, the suggestion machine learning model 570 can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

As an example, the suggestion machine learning model 570 can be configured to generate a classification output that identifies a predicted modification type for the updated structured data file 550(e) from a set of potential modification types. For example, the suggestion machine learning model 570 can generate a classification output that identifies a predicted modification to change the color scheme of the structured data file, to separate one or more components into related sub-components, or to rearrange the order of the components.

In this case, a training system, e.g., the system or another system, can have trained the suggestion machine learning model 570 using training data that includes (i) a set of first structured data files with corresponding metadata, and (ii) a corresponding ground truth classification of a modification type indicated by a request made to modify the structured data file. In particular, the training system can train the suggestion machine learning model on the set of training examples by a machine learning technique to optimize an objective function, e.g., a mean-squared error loss or a cross-entropy loss. For example, the suggestion machine learning model 570 can be trained by calculating and backpropagating gradients of an objective function to update parameter values of the model, e.g., using the update rule of any appropriate gradient descent optimization algorithm, e.g., RMSprop or Adam.

As another example, the suggestion machine learning model 570 can be a generative model, e.g., a generative-adversarial network or an autoregressive language processing neural network. In this case, the suggestion machine learning model can be configured to generate a textual suggestion that includes a description of a predicted modification, as is described with respect to FIG. 3. For example, the execution engine 505 can be configured to process the updated structured data file 550(e) and the metadata 535 with an instruction to generate one or more suggested revisions for the updated structured data file 550(e) using a language processing neural network to generate suggestions 575. In some cases, the suggestion machine learning model 570 can be implemented as the same language processing neural network that is used to process the textual input 522 to generate the updated structured data file 550(a), e.g., the language processing neural network 520.

In this case, the language processing neural network 520 can have been finetuned to generate suggestions for structured data files. For example, a finetuning system, e.g., the system or another system, can obtain finetuning data that includes a (i) set of structured data files with corresponding metadata and (ii) corresponding sets of one or more ground truth requests for each of the set of structured data files. In some cases, the system can generate the finetuning data by logging requests received for a number of structured data files and maintaining the number of structured data files, e.g., in the structured data file database 560.

The finetuning system can have finetuned the language processing neural network at each of a number of finetuning iterations. In particular, the finetuning system can generate one or more predicted modifications for each structured data file in the training data, e.g., by processing the structured data file using the language processing neural network at a particular finetuning iteration, and can update a set of parameter values of the language processing neural network at the particular finetuning iteration by minimizing a discrepancy between the one or more generated predicted modifications and the corresponding set of one or more ground truth requests for each of the structured data files in the finetuning data. More specifically, the finetuning system can finetune the language processing neural network by updating the respective values of parameters of the model using the update rule of any appropriate gradient descent optimization algorithm, e.g., RMSprop, or Adam.

In the case that the modification subsystem 500 generates suggestions 575, the subsystem 500 can provide the suggestions 575 to the client device with the updated structured data file 550(e), e.g., the updated structured data file 550(a), 550(b), 550(c), 550(d), etc., for further editing.

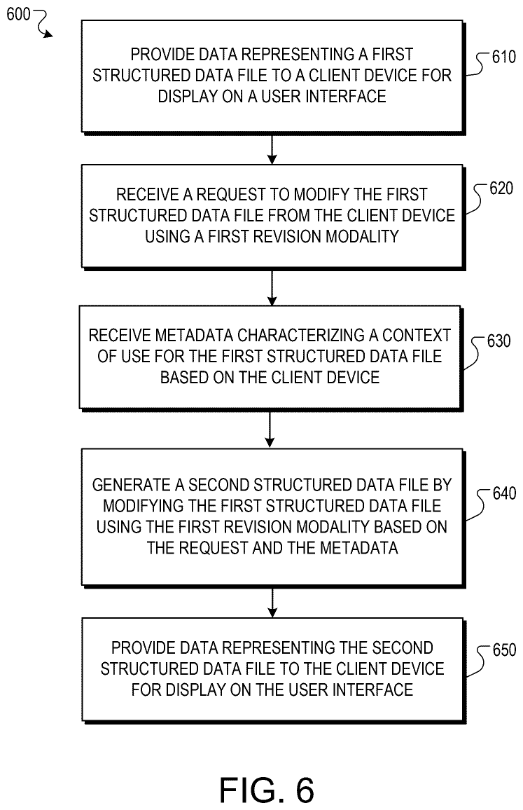

FIG. 6 is a flow diagram of an example process for updating a structured data file using a specific revision modality based on a request and metadata. For convenience, the process 600 will be described as being performed by a system of one or more computers located in one or more locations. For example, a structured data file update system, e.g., the structured data file update system 100 of FIG. 1, appropriately programmed in accordance with this specification, can perform the process 600.

The system can provide data representing a first structured data file to a client device for display on a user interface (step 610). In particular, the first structured data file is referred to as a structured data file since it is structured according to a schema, e.g., a set organization of the data file according to predefined relationships between one or more components of the structured data file. For example, the first structured data file can be an HTML, XML, or JSON file that specifies the relationships between components of the schema using a nested dictionary structure.

More specifically, the system can obtain the first structured data file. As an example, the system can have generated the first structured data file, e.g., the system can receive an input including a request to generate the first structured data file based on the schema, and can process the request using a language processing neural network to generate the first structured data file. As another example, the system can access the first structured data file from the client device, e.g., from a data storage location of the client device. As yet another example, the system can obtain the first structured data file from a different system.

The system can receive a request to modify the first structured data file from the client device using a first revision modality (step 620). The first revision modality can be selected from a set of one or more revision modalities that are compatible with the schema. For example, the set of one or more revision modalities that are compatible with the schema can include a textual input revision modality, a user-interface input revision modality, and a code input revision modality. In particular, the system can be configured to provide a set of revision modalities that can be used to revise the schema to the client device for selection.

The system can also receive metadata characterizing a context of use for the first structured data file based on the client device (step 630). In particular, the metadata can provide context to the system to ensure that the request is valid and specifies a modification that aligns with the intended use of the structured data file. For example, the received metadata can be generated using data accessed from the client device and contextual domain knowledge data. In some cases, the system can receive the metadata from another system.

The system can then generate a second structured data file by modifying the first structured data file using the first revision modality based on the request and the metadata (step 640). In some cases, the system can use the obtained metadata to validate the request, e.g., to ensure that the modification specified by the request to the structured data file is in accordance with the schema of a database maintained by the client device as well as related validations, constraints, and check conditions. In this case, in response to validating the request, the system can generate the second structured data file by modifying the first structured data file based on the validated request.

As an example, in the case that the first revision modality is the textual input revision modality, the system can receive the request as a textual instruction specifying one or more modifications to the first structured data file. In this case, the system can generate the second structured data file by processing the first structured data file and the metadata with the textual instruction using a language processing neural network to generate the second structured data file including the one or more specified modifications to the first structured data file. For example, the language processing neural network can be a large language model and the request can be a prompt, e.g., a directive instruction to modify the first structured data file according to the one or more modifications.

As another example, in the case that the first revision modality is the user-interface input modality, the system can receive the request by way of the user-interface. In this case, the system can receive modifications to one or more components of the schema by way of the user interface and can generate the second structured data file based on the modifications to the one or more components of the schema. For example, the system can receive modifications to the one or more components, e.g., pages, panels, columns, or themes, of the schema by way of an interaction with the user interface. In particular, the system can receive an indication of a selection of a first component by way of the user interface. In response to the indication of the selection of the first component, the system can provide a number of options specifying respective modifications to the first component in accordance with the metadata, and can receive a selection of an option specifying a first modification to the component.

As yet another example, in the case that the first revision modality is the code input revision modality, the system can receive the request by the client device directly modifying the first structured data file. For example, the first structured data file can include code specifying instructions for an application and the client device can directly update the first structured data file, thereby modifying the underlying application.

The system can provide data representing the second structured data file to the client device for display on the user interface (step 650). In particular, the system can provide the data for rendering on the client device, e.g., so a user of the client device can evaluate the revisions made in accordance with the request to modify the first structured data file using the first revision modality. In some cases, the system can also maintain the first and second structured data files in a structured data file repository, e.g., by associating the first and second structured data files in the structured data file repository as respective versions of the first structured data file.

For example, in the case that the first structured data file includes code specifying instructions for an application, e.g., a JSON file, the system can execute the code specifying instructions for an application and can provide the application to the client device for rendering by way of the user interface. As an example, the application can be a data management application that displays data obtained through a data entry form. In this case, executing the code for the application can further involve accessing data from a data repository, e.g., for display with the form specified by the first structured data file.

In some cases, the system can additionally provide suggestions, e.g., predicted modifications, to the client device regarding further modification of the second structured data file. As an example, the system can generate one or more suggestions to the second structured data file by processing the second structured data file and the metadata using a suggestion machine learning model. The system can then provide data representing the one or more suggestions to the client device, e.g., with the second structured data file.

For example, the suggestion machine learning model can be a language processing neural network. In some cases, the suggestion machine learning model can be the language processing neural network that the system uses to update the structured data file using the textual input revision modality. In the case that the suggestion machine learning model is a language processing neural network, the system or another system can have finetuned the language processing neural network using finetuning data that includes (i) a set of first structured data files with corresponding metadata, and (ii) corresponding sets of one or more ground truth requests to modify each of the set of first structured data files. As an example, the system can generate the finetuning data by logging requests received for the set of first structured data files and maintaining the set of first structured data files, e.g., in the structured data file repository.

In particular, the system or another system can generate one or more predicted modifications for each of the first structured data files by processing the first structured data file using the language processing neural network with an instruction to generate one or more suggested revisions for the first structured data file. The system or another system can then update a set of parameter values of the language processing neural network in accordance with minimizing a discrepancy between the one or more generated predicted modifications and the set of one or more ground truth requests for each of the first structured data files.

In some cases, the system can receive an additional request for further updating. For example, the system can receive a second request to modify the second structured data file from the client device that indicates a second revision modality selected from the set of one or more revision modalities that are compatible with the schema. As another example, in the case that the system generates suggestions using a suggestion machine learning model, the system can receive a second request that includes one or more of the suggestions provided to the client device for further editing of the second structured data file, e.g., the suggestion can be associated with a second revision modality. After receiving the additional request, the system can generate a third structured data file by modifying the second structured data file using the second revision modality based on the second request and the metadata.

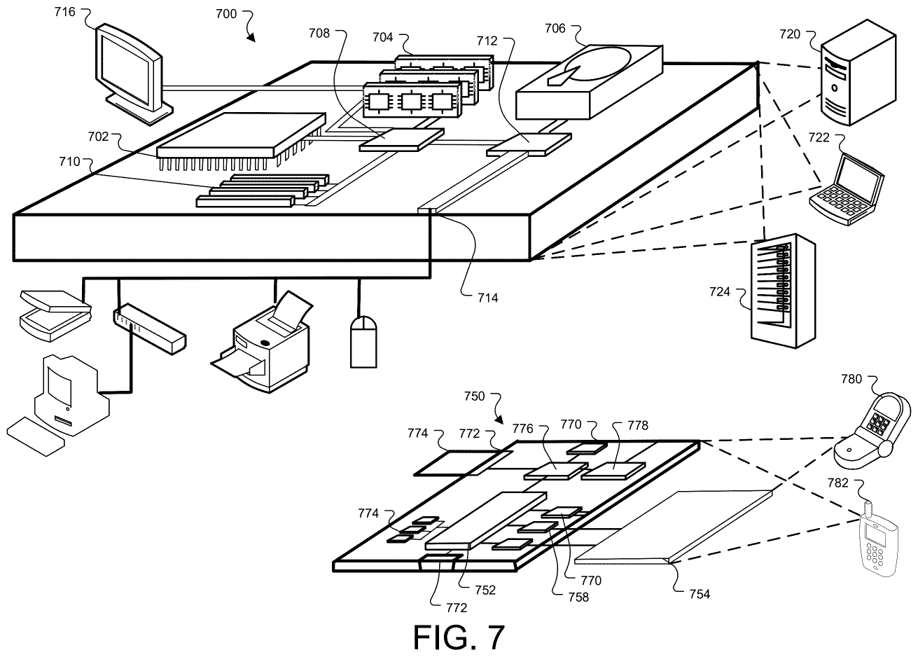

FIG. 7 shows an example of example computer device 700 and example mobile computer device 750, which can be used to implement the techniques described herein. For example, a portion or all of the operations for updating a structured data file using a specific revision modality based on a request and metadata, etc. may be executed by the computer device 700 and/or the mobile computer device 750. Computing device 700 is intended to represent various forms of digital computers, including, e.g., laptops, desktops, workstations, personal digital assistants, servers, blade servers, mainframes, and other appropriate computers. Computing device 750 is intended to represent various forms of mobile devices, including, e.g., personal digital assistants, tablet computing devices, cellular telephones, smartphones, and other similar computing devices. The components shown here, their connections and relationships, and their functions, are meant to be examples only, and are not meant to limit implementations of the techniques described and/or claimed in this document.

Computing device 700 includes processor 702, memory 704, storage device 706, high-speed interface 708 connecting to memory 704 and high-speed expansion ports 710, and low-speed interface 712 connecting to low-speed bus 714 and storage device 706. Each of components 702, 704, 706, 708, 710, and 712, are interconnected using various busses, and can be mounted on a common motherboard or in other manners as appropriate. Processor 702 can process instructions for execution within computing device 700, including instructions stored in memory 704 or on storage device 706 to display graphical data for a GUI on an external input/output device, including, e.g., display 716 coupled to high-speed interface 708. In other implementations, multiple processors and/or multiple busses can be used, as appropriate, along with multiple memories and types of memory. Also, multiple computing devices 700 can be connected, with each device providing portions of the necessary operations (e.g., as a server bank, a group of blade servers, or a multi-processor system).

Memory 704 stores data within computing device 700. In one implementation, memory 704 is a volatile memory unit or units. In another implementation, memory 704 is a non-volatile memory unit or units. Memory 704 also can be another form of computer-readable medium (e.g., a magnetic or optical disk. Memory 704 may be non-transitory.) Storage device 706 is capable of providing mass storage for computing device 700. In one implementation, storage device 706 can be or contain a computer-readable medium (e.g., a floppy disk device, a hard disk device, an optical disk device, or a tape device, a flash memory or other similar solid state memory device, or an array of devices, such as devices in a storage area network or other configurations.) A computer program product can be tangibly embodied in a data carrier. The computer program product also can contain instructions that, when executed, perform one or more methods (e.g., those described above.) The data carrier is a computer-or machine-readable medium, (e.g., memory 704, storage device 706, memory on processor 702, and the like.) High-speed controller 708 manages bandwidth-intensive operations for computing device 700, while low-speed controller 712 manages lower bandwidth-intensive operations. Such allocation of functions is an example only. In one implementation, high-speed controller 708 is coupled to memory 704, display 716 (e.g., through a graphics processor or accelerator), and to high-speed expansion ports 710, which can accept various expansion cards (not shown). In the implementation, low-speed controller 712 is coupled to storage device 706 and low-speed expansion port 714. The low-speed expansion port, which can include various communication ports (e.g., USB, Bluetooth®, Ethernet, wireless Ethernet), can be coupled to one or more input/output devices, (e.g., a keyboard, a pointing device, a scanner, or a networking device including a switch or router, e.g., through a network adapter.) Computing device 700 can be implemented in a number of different forms, as shown in the figure. For example, it can be implemented as standard server 720, or multiple times in a group of such servers. It also can be implemented as part of rack server system 724. In addition or as an alternative, it can be implemented in a personal computer (e.g., laptop computer 722.) In some examples, components from computing device 700 can be combined with other components in a mobile device (not shown), e.g., device 750. Each of such devices can contain one or more of computing device 700, 750, and an entire system can be made up of multiple computing devices 700, 750 communicating with each other.

Computing device 750 includes processor 752, memory 764, an input/output device (e.g., display 754, communication interface 766, and transceiver 768) among other components. Device 750 also can be provided with a storage device, (e.g., a microdrive or other device) to provide additional storage. Each of components 750, 752, 764, 754, 766, and 768, are interconnected using various buses, and several of the components can be mounted on a common motherboard or in other manners as appropriate.

Processor 752 can execute instructions within computing device 750, including instructions stored in memory 764. The processor can be implemented as a chipset of chips that include separate and multiple analog and digital processors. The processor can provide, for example, for coordination of the other components of device 750, e.g., control of user interfaces, applications run by device 750, and wireless communication by device 750.

Processor 752 can communicate with a user through control interface 758 and display interface 756 coupled to display 754. Display 754 can be, for example, a TFT LCD (Thin-Film-Transistor Liquid Crystal Display) or an OLED (Organic Light Emitting Diode) display, or other appropriate display technology. Display interface 756 can comprise appropriate circuitry for driving display 754 to present graphical and other data to a user. Control interface 758 can receive commands from a user and convert them for submission to processor 752. In addition, external interface 762 can communicate with processor 742, so as to enable near area communication of device 750 with other devices. External interface 762 can provide, for example, for wired communication in some implementations, or for wireless communication in other implementations, and multiple interfaces also can be used.

Memory 764 stores data within computing device 750. Memory 764 can be implemented as one or more of a computer-readable medium or media, a volatile memory unit or units, or a non-volatile memory unit or units. Expansion memory 774 also can be provided and connected to device 750 through expansion interface 772, which can include, for example, a SIMM (Single In Line Memory Module) card interface. Such expansion memory 774 can provide extra storage space for device 750, or also can store applications or other data for device 750. Specifically, expansion memory 774 can include instructions to carry out or supplement the processes described above, and can include secure data also. Thus, for example, expansion memory 774 can be provided as a security module for device 750, and can be programmed with instructions that permit secure use of device 750. In addition, secure applications can be provided through the SIMM cards, along with additional data, (e.g., placing identifying data on the SIMM card in a non-hackable manner.) The memory 764 can include, for example, flash memory and/or NVRAM memory, as discussed below. In one implementation, a computer program product is tangibly embodied in a data carrier. The computer program product contains instructions that, when executed, perform one or more methods, e.g., those described above. The data carrier is a computer-or machine-readable medium (e.g., memory 764, expansion memory 774, and/or memory on processor 752), which can be received, for example, over transceiver 768 or external interface 762.

Device 750 can communicate wirelessly through communication interface 766, which can include digital signal processing circuitry where necessary. Communication interface 766 can provide for communications under various modes or protocols (e.g., GSM voice calls, SMS, EMS, or MMS messaging, CDMA, TDMA, PDC, WCDMA, CDMA2000, or GPRS, among others.) Such communication can occur, for example, through radio-frequency transceiver 768. In addition, short-range communication can occur, e.g., using a Bluetooth®, WiFi, or other such transceiver (not shown). In addition, GPS (Global Positioning System) receiver module 770 can provide additional navigation-and location-related wireless data to device 750, which can be used as appropriate by applications running on device 750. Sensors and modules such as cameras, microphones, compasses, accelerators (for orientation sensing), etc. may be included in the device.

Device 750 also can communicate audibly using audio codec 760, which can receive spoken data from a user and convert it to usable digital data. Audio codec 760 can likewise generate audible sound for a user, (e.g., through a speaker in a handset of device 750.) Such sound can include sound from voice telephone calls, can include recorded sound (e.g., voice messages, music files, and the like) and also can include sound generated by applications operating on device 750.

Computing device 750 can be implemented in a number of different forms, as shown in the figure. For example, it can be implemented as cellular telephone 780. It also can be implemented as part of smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor. The programmable processor can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a device for displaying data to the user (e.g., a CRT (cathode ray tube) or LCD (liquid crystal display) monitor), and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a backend component (e.g., as a data server), or that includes a middleware component (e.g., an application server), or that includes a frontend component (e.g., a client computer having a user interface or a Web browser through which a user can interact with an implementation of the systems and techniques described here), or a combination of such back end, middleware, or frontend components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

1. A computer-implemented method comprising:
providing data representing a first structured data file to a client device for display on a user interface, wherein the first structured data file is structured according to a schema;
receiving a request to modify the first structured data file from the client device, wherein the request to modify the first structured data file indicates a first revision modality for modifying the first structured data file that is selected from a set of one or more revision modalities that are compatible with the schema;
receiving metadata characterizing a context of use for the first structured data file based on the client device, wherein the metadata comprises an indication of at least one domain-specific purpose of the first structured data file;
generating a second structured data file by modifying the first structured data file using the first revision modality based on the request and in accordance with the at least one domain-specific purpose specified by the metadata; and
providing data representing the second structured data file to the client device for display on the user interface.

2. The computer-implemented method of claim 1, further comprising:
receiving a second request to modify the second structured data file from the client device, wherein the request to modify the second structured data file indicates a second revision modality selected from the set of one or more revision modalities that are compatible with the schema; and
generating a third structured data file by modifying the second structured data file using the second revision modality based on the second request and in accordance with the at least one domain-specific purpose specified by the metadata.

3. The computer-implemented method of claim 1, wherein the received metadata is generated using data accessed from the client device and contextual domain-knowledge data.

4. The computer-implemented method of claim 1, wherein generating the second structured data file by modifying the first structured data file using the first revision modality based on the request and in accordance with the at least one domain-specific purpose specified by the metadata comprises:
validating the request in accordance with the received metadata; and
in response to validating the request, generating the second structured data file by modifying the first structured data file based on the validated request.

5. The computer-implemented method of claim 1, further comprising maintaining the first and second structured data files in a structured data file repository, wherein maintaining comprises associating the first and second structured data files in the structured data file repository as respective versions of the first structured data file.

6. The computer-implemented method of claim 1, further comprising:
generating one or more suggestions comprising predicted modifications to the second structured data file by processing the second structured data file and the metadata using a suggestion machine learning model; and
providing data representing the one or more suggestions to the client device.

7. The computer-implemented method of claim 1, wherein the set of one or more revision modalities that are compatible with the schema comprises:
a textual input revision modality;
a user-interface input revision modality; and
a code input revision modality.

8. A system comprising:
a computing device comprising:
a memory configured to store instructions; and
a processor to execute the instructions to perform operations comprising:
providing data representing a first structured data file to a client device for display on a user interface, wherein the first structured data file is structured according to a schema;
receiving a request to modify the first structured data file from the client device, wherein the request to modify the first structured data file indicates a first revision modality for modifying the first structured data file that is selected from a set of one or more revision modalities that are compatible with the schema;
receiving metadata characterizing a context of use for the first structured data file based on the client device, wherein the metadata comprises an indication of at least one domain-specific purpose of the first structured data file;
generating a second structured data file by modifying the first structured data file using the first revision modality based on the request and in accordance with the at least one domain-specific purpose specified by the metadata; and
providing data representing the second structured data file to the client device for display on the user interface.

9. The system of claim 8, further comprising:
receiving a second request to modify the second structured data file from the client device, wherein the request to modify the second structured data file indicates a second revision modality selected from the set of one or more revision modalities that are compatible with the schema; and
generating a third structured data file by modifying the second structured data file using the second revision modality based on the second request and in accordance with the at least one domain-specific purpose specified by the metadata.

10. The system of claim 8, wherein the received metadata is generated using data accessed from the client device and contextual domain-knowledge data.

11. The system of claim 8, wherein generating the second structured data file by modifying the first structured data file using the first revision modality based on the request and in accordance with the at least one domain-specific purpose specified by the metadata comprises:
validating the request in accordance with the received metadata; and
in response to validating the request, generating the second structured data file by modifying the first structured data file based on the validated request.

12. The system of claim 8, further comprising maintaining the first and second structured data files in a structured data file repository, wherein maintaining comprises associating the first and second structured data files in the structured data file repository as respective versions of the first structured data file.

13. The system of claim 8, further comprising:
generating one or more suggestions comprising predicted modifications to the second structured data file by processing the second structured data file and the metadata using a suggestion machine learning model; and
providing data representing the one or more suggestions to the client device.

14. The system of claim 8, wherein the set of one or more revision modalities that are compatible with the schema comprises:
a textual input revision modality;
a user-interface input revision modality; and
a code input revision modality.

15. One or more computer readable media storing instructions that are executable by a processing device, and upon such execution cause the processing device to perform operations comprising:
providing data representing a first structured data file to a client device for display on a user interface, wherein the first structured data file is structured according to a schema;
receiving a request to modify the first structured data file from the client device, wherein the request to modify the first structured data file indicates a first revision modality for modifying the first structured data file that is selected from a set of one or more revision modalities that are compatible with the schema;
receiving metadata characterizing a context of use for the first structured data file based on the client device, wherein the metadata comprises an indication of at least one domain-specific purpose of the first structured data file;
generating a second structured data file by modifying the first structured data file using the first revision modality based on the request and in accordance with the at least one domain-specific purpose specified by the metadata; and
providing data representing the second structured data file to the client device for display on the user interface.

16. The computer readable media of claim 15, further comprising:
receiving a second request to modify the second structured data file from the client device, wherein the request to modify the second structured data file indicates a second revision modality selected from the set of one or more revision modalities that are compatible with the schema; and
generating a third structured data file by modifying the second structured data file using the second revision modality based on the second request and in accordance with the at least one domain-specific purpose specified by the metadata.

17. The computer readable media of claim 15, wherein the received metadata is generated using data accessed from the client device and contextual domain-knowledge data.

18. The computer readable media of claim 15, wherein generating the second structured data file by modifying the first structured data file using the first revision modality based on the request and in accordance with the at least one domain-specific purpose specified by the metadata comprises:
validating the request in accordance with the received metadata; and
in response to validating the request, generating the second structured data file by modifying the first structured data file based on the validated request.

19. The computer readable media of claim 15, further comprising maintaining the first and second structured data files in a structured data file repository, wherein maintaining comprises associating the first and second structured data files in the structured data file repository as respective versions of the first structured data file.

20. The computer readable media of claim 15, further comprising:
generating one or more suggestions comprising predicted modifications to the second structured data file by processing the second structured data file and the metadata using a suggestion machine learning model; and
providing data representing the one or more suggestions to the client device.

21. The computer readable media of claim 15, wherein the set of one or more revision modalities that are compatible with the schema comprises:
a textual input revision modality;
a user-interface input revision modality; and
a code input revision modality.
